(19) United States
(12) Patent Application Publication
(10) Pub. No.: US 2006/0137498 A1
(43) Pub. Date: Jun. 29, 2006

(54) Offset blade for making flush cuts with a reciprocating saw

(76) Inventor: Scott Bowling, Cincinnati, OH (US)

Correspondence Address: JOHN B. WOODARD, 8657 TWILIGHT TEAR LANE, CINCINNATI, OH, 45249, US

(21) Appl. No.: 11/321,343

(22) Filed: Dec. 29, 2005

Related U.S. Application Data
(60) Provisional application No. 60/639,899, filed on Dec. 29, 2004.

(51) Int. Cl. B23D 57/00; B27B 13/02

(52) U.S. Cl. 83/13; 83/835

(57) ABSTRACT

An apparatus and method for allowing the cutting portion of the blade of a reciprocating saw to reciprocate along a path that is offset from the axis of reciprocation of the reciprocating saw bar is provided. The blade is made with an offset to move the the cutting portion of the saw blade away from and parallel to the axis of reciprocation of the saw bar. By offsetting the cutting portion of the blade it can be possible to make cuts that are flush with an element of the cutting situation which otherwise precludes the saw body passing through it and limits the usefulness of the saw.

### CROSS REFERENCE TO RELATED APPLICATION

This application claims the benefit of co-pending U.S. Provisional Patent Application No. 60/639,899 filed Dec. 29, 2004.

### BACKGROUND OF THE INVENTION

Reciprocating saws are electrically or mechanically powered saws which have a blade that extends outward, away from the body of the saw. Typically, the body of the saw comprises the motor or power unit of the saw along with a handling mechanism to control the action of the saw, various guiding means, motor, cutting controls, and case. The blade is usually attached to a reciprocating element of the saw often called a saw bar, which supports one end of the blade, allowing the free end to penetrate, without support, the work or material being cut. The blade is driven by the motor or power unit of the saw in a reciprocal motion in which the blade is alternately extended away from the saw body and drawn back toward the saw body by the saw bar which is the powered element of the saw to which the saw blade is attached.

When reciprocating saws are used, they are often limited in their use by the fact that the blades are mounted centrally on the saw body. For example, in the case of a scroll saw or saber saw, which are embodiments of a reciprocating saw, the saw blade is usually mounted so that it protrudes through a flat plate often called a foot or foot plate, usually in the form of a metal plate, mounted on the saw. In this particular case, the foot precludes the saw blade being able to cut close to features of the work that extend away from the surface in which the saw blade is cutting, particularly, if such features extend toward the saw body at some angle from the surface in which the blade is cutting. The foot plate or the saw body typically encounter the feature's surface formed by the extension of the feature away from the surface being cut or work surface and prohibit the blade reaching the corner, crease, intersection or edge formed by the feature as it extends away from the surface being cut.

Other types of reciprocating saws do not have a plate as is common with scroll saws, but the saw blade is still mounted in a way which precludes the blade reaching a corner or crease or edge as described above. This is especially true when the feature extends away from the work surface toward the saw body. Other elements of the cutting situation can also interfere with the saw body precluding the approach of the saw blade to certain areas of the work being cut. Often the saw body is simply in the way of the saw blade because of the interfering element, constraining the saw blade from being moved adjacent the feature to cut close to it.

An example is the case of a reciprocating saw being used to make a vertical or horizontal cut along the corner formed between a floor and a wall, called a flush cut or flush-to cut. Normally, the saw blade is mounted on the reciprocating saw in a manner prohibiting the saw blade from moving in the plane of either surface forming the corner so as to make a cut along the corner in the plane of either surface. Consequently, to make a cut along the crease or corner in the plane of one of the surfaces forming the corner, one flexes the blade risking blade breakage, personal injury, and in some cases not being able to make the cut at all. When such cuts are even attempted, the results are usually not as intended and are always unpredictable due to the uncontrolled flex of the saw blade necessary to attempt the in-plane cut.

To improve blade stability in such applications, at least one manufacturer has built a tool that can be mounted on the saw bar of the reciprocating saw and that allows the saw blade to be mounted on an extension that is perpendicular to the direction of motion of the saw blade. This offsets the blade to a position where the saw blade can be parallel to one of the surfaces as in the case of cutting along the intersection of a wall rising from a floor. Though it can improve overall blade stability, mounting hardware used to secure the blade in position can extend on either side of the blade and preclude the blade from traveling flush to the surface along which the cut is being made.

### BRIEF DESCRIPTION OF THE INVENTION

A saw blade is provided for mounting on the saw bar of a reciprocating saw. The blade is formed of a single piece of material with an offset portion that offsets a cutting portion of the saw blade from the axis of reciprocation of the saw bar. In this way the line of cut of the saw is offset from the axis of reciprocation of the saw bar.

A saw blade for a reciprocating saw comprising a plurality of parts is also provided. The plurality of parts is assembled causing a cut provided by the saw blade to be offset from the axis of reciprocation of a saw bar. The saw bar is the part of the reciprocating saw to which the saw blade is attached. The saw blade is comprised of the following parts: an attachment portion of the blade for attaching the blade to the saw bar, an offset portion of the blade for offsetting the cutting portion of the blade from the axis of reciprocation of the saw bar, a cutting portion of the blade for supporting a leading edge of the cutting portion of the blade which supports means for cutting, and means for attaching the parts together to form the blade.

From another viewpoint a method for making flush cuts to a protruding element from a work surface being cut when using a reciprocating saw is provided. It comprises several steps. First a blade is made for the reciprocating saw from a single piece of material. It comprises an attachment portion, an offset portion, and a cutting portion. The offset portion is adjusted in length to allow the blade to reciprocate outside the boundaries of the saw body when it is attached to the saw. When a protruding element on a surface is undercut in the plane of the work surface, the cutting portion can be applied to allow the cutting portion of the blade to reciprocate substantially in the plane of the work surface. Alternatively, when cutting into the work surface proximate the protrusion element but not under it, the cutting portion of the blade can reciprocate substantially perpendicular to the work surface and avoids limitations to the cut line that can be caused by the protrusion. In all cases the saw blade is passed through the material to cut the material.

### BRIEF DESCRIPTION OF THE DRAWINGS

FIG. 1 is a view of a reciprocal saw and saw blade in a cutting situation;

FIG. 2A is a view of a reciprocal saw blade with offset;

FIG. 2B is a view of a reciprocal saw blade with offset;

FIG. 3 is a view of a reciprocal saw blade according to one embodiment;

FIG. 4 is a view of a reciprocal saw blade according to one embodiment;

FIG. 5 is a view of a reciprocal saw blade mounted in a reciprocal saw;

FIG. 6 is a view of a reciprocal saw blade according to one embodiment;

FIG. 7 is a view of a reciprocal saw blade with offset;

FIG. 8 is a view of a reciprocal saw blade with a pitched blade;

FIG. 9 is a view of a multiple piece reciprocal saw blade;

FIG. 10 is a view of a reciprocal saw blade with adjustable offset; and

FIG. 11 is a saw with positionable saw blade.

### DETAILED DESCRIPTION OF THE INVENTION

The invention comprises an apparatus and method for allowing the cutting portion of the blade of a reciprocating saw to reciprocate along a path that is offset from the axis of reciprocation of the reciprocating saw bar. The axis of reciprocation of the saw bar is defined by the reciprocating motion of the saw bar and in cross section is the same as the cross section of the saw bar. The saw bar is the driving element of the saw for propelling the saw blade in its reciprocating motion.

By offsetting the cutting portion of a blade it becomes possible to make cuts that are flush with an element of the cutting situation that precludes the saw body passing through it and limits the usefulness of the saw. An example of this is a wall or other obstructing element rising from a floor in which a cut is made. If one wants to make a cut along the intersection of the wall or other obstructing element and the floor, the saw body, which is the rest of the saw except for the blade, interferes unless the cutting portion of the blade is positioned to operate free of the interference of the saw body. This is especially true when the desired cut is to be made along the intersection of the two intersecting elements and is coplanar with one of them.

A blade is formed so as to allow the cutting portion of the blade to move in a surface that is parallel to and offset from the axis of reciprocation of the saw bar. The cut made can be parallel to the axis of reciprocation of the saw bar to allow the cutting edge of the blade to cut utilizing the reciprocating motion of the saw. When the cut is made in a parallel surface, the parallel surface can be defined by the cut line. That is a surface parallel to the axis of reciprocation that follows the cut line or track along which the saw blade moves as it cuts the work.

The blade can be a single piece of metal that is formed to allow the offset cut, or it can comprise multiple pieces. In every case the blade is formed so that there are no protruding features of the blade that extend outward from the outer edge of the blade. By avoiding such extensions the blade is always free to move without interference in the plane of or adjacent any surface in which a coplanar cut into a protrusion from the planar surface is desired.

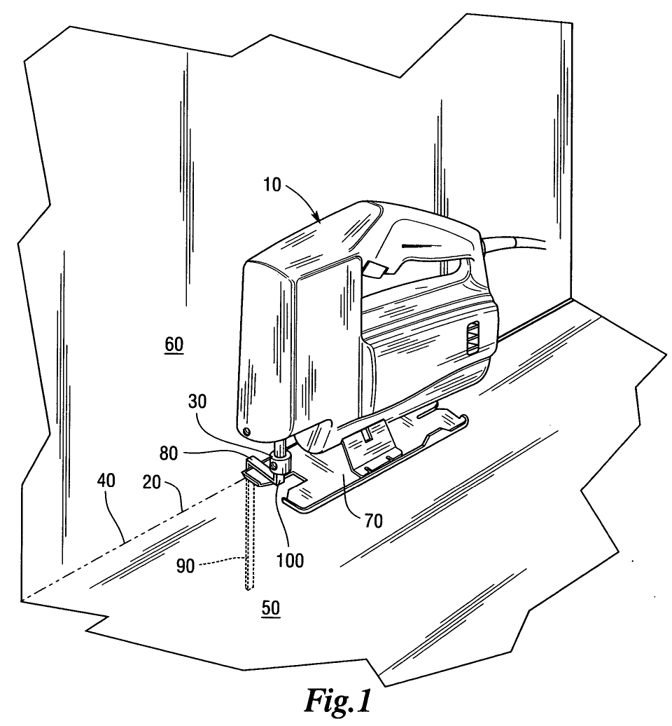

Referring to the drawings, FIG. 1 is a reciprocating saw employing the invention showing the saw 10 cutting along a cut line 20 which is offset from the axis of the saw bar 30. In the embodiment shown, the saw 10 is making a flush cut along cut line 20 which is congruent with the intersection 40 of a floor 50 and a wall 60. In the case shown the saw 10 comprises a foot plate 70 which allows the offset 80 feature of the saw blade 100 to function above the floor surface 50 allowing the cutting portion 90 of the saw blade 100 to engage and cut along the intersection 40 of the wall 60 and the floor 50.

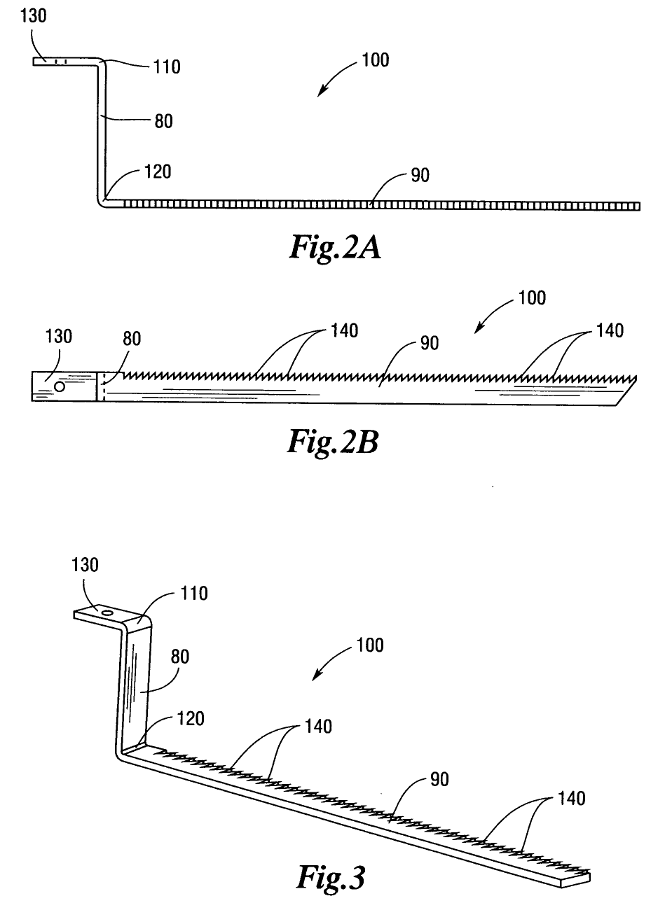

FIG. 2A is an edge on view of one embodiment of a saw blade 100 showing a single piece of material forming the saw blade 100. The blade 100 incorporates a first angle 110 and a second angle 120 which provide an offset 130 to its cut line 20 from the axis of reciprocation of the saw 10. The two angles 110 and 120 serve to move the cutting portion 90 of the blade 100 away from the plane of the saw bar 30 to which the attachment portion 130 of the blade 100 is affixed by means peculiar to the exact geometry of the saw 10 used. The attachment portion 130 is of sufficient length and shape to fit the reciprocating saw 10 being used. The offset portion 80 of the blade 100 is of sufficient length to position the cut line 20 of the saw blade 100, the line along which the saw blade 100 cuts the work, sufficiently far from the saw bar 30 so that any interference from the saw body, being obstructed by an element of the cutting situation, to the free motion of the saw blade 100 is avoided.

As shown in FIG. 2A angle 110 and angle 120 are about 90 degree angles. These angles can be different than 90 degrees so long as in combination they allow the saw blade 100 to cut in a plane of cut that is about parallel to the reciprocating saw bar 30. The cutting portion of the blade 90 could be pitched forward or backward along the plane of cut to provide for undercutting a point on the surface of the work or back cutting behind a point on the surface of the work.

FIG. 2B is a top view of the saw blade 100 shown in FIG. 2A showing that the cutting portion 90 of the blade 100 is in alignment with the attachment portion of the blade 130 such that reciprocation of the saw bar 30 would allow the cutting teeth 140 of the saw blade 100 to reciprocate in a plane that is parallel to the axis of reciprocation of the saw bar 30.

FIG. 3 is a view of the saw blade 100 of FIG. 2A showing the single piece saw blade's 100 cutting teeth 140 positioned along the leading edge of the saw blade 100. Although, in the example, cutting teeth 140 are shown, the mechanism of cutting or dividing material could include other cutting means such as an abrasive edge, heated blade or wire, a file edge, or other material dividing edge incorporated in or attached to the saw blade 100. The saw blade 100 is formed from a single piece of material.

When the saw blade 100 offsets to the side of the saw 10, the material used to form the saw blade 100 is of sufficient thickness to limit undesirable flexing of the saw blade 100. For this reason, the thickness of material in the saw blade 100 can be adjusted for the different portions of the saw blade 100. For example it is sometimes desirable to make the attachment portion 130 of the blade 100 and the offset portion 80 of the saw blade 100 of thicker material than the thickness of the cutting portion 90 of the blade 100 to limit flex in the blade 100 encountered when the blade 100 is reciprocating. Flex can cause unwanted heat generation and can also limit the precision of the cut. This can occur when the blade 100 is reciprocating at high speed causing the cutting portion 90 of the blade 100 to vibrate, especially, when the vibration mode is transverse to the direction of the cut being made. Alternatively, the attachment portion 130 and/or the offset portion 80 of the blade 100 can be stiffened by hardening, heat treating or other means. As noted above, the angles 110 and 120 need not be strictly 90 degrees, but rather in combination allow the cutting portion 90 of the saw blade 100 to reciprocate about in parallel with the saw bar 30. Limitation of flex, unwanted heat generation, and vibration are especially important when one wants to conserve material by limiting the width of the saw kerf, which is the void line of material removed from the work in cutting, or limiting the material removed as the saw blade 100 makes its cut as well as when one wants to maximize the precision of the cut.

Regardless of the actual measurement of the angles 110 and 120, one method of limiting saw blade 100 vibrations is to support or strengthen the angles 110 and 120 formed by the non-linear or bent saw blade 100. This can be accomplished by various methods such as adding material to the inside curvature of the bends 110 and 120 to increase the thickness of the metal that comprises the bends 110 and 120, placing a short reinforcing strut across the sides forming the inside angles 110 and 120, reinforcing by attaching extra material to in the bend area, forming the angles 110 and 120 from heavier solid material, forming the bends 110 and 120 so that they are comprised of solid material, forming all but the cutting portion of heavier material unlikely to exhibit unwanted movement, or using other means for building the non-cutting portion of the blade robustly to limit or eliminate unwanted movement.

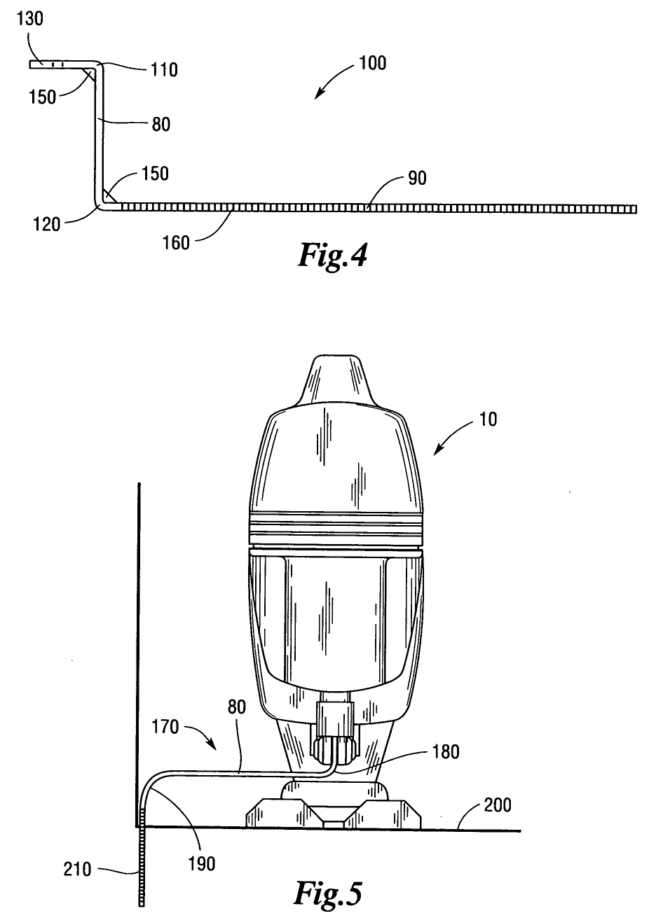

FIG. 4 shows an embodiment wherein the angles 110 and 120 of the saw blade 100 have been reinforced with reinforcing material 150 placed into the inside angles 110 and 120.

The cutting portion 90 of the blade 100 has no protrusions extending outward further away from the saw body 10 than the outer side 160 of the cutting portion 90 of the blade 100 as would be needed if the cutting portion 90 of the blade 100 were mounted on an offset portion 80 of the blade 100 with the cutting portion 90 being a separate straight blade attached to the offset portion 80 of the blade 100 by mechanical means such as a screw to hold the offset portion 80 together with the cutting portion 90 of the blade 100. Because of this, a flush cut with no blade flexing can be made against a wall as in the example of a cut needing to be made along the base of a wall where it meets the floor of a building.

Typically, the saw blade 100 is formed of metal, but the saw blade 100 can be made of other material having suitable properties for the intended use or application.

In another embodiment, as shown in FIG. 5, the saw blade 170 can be formed with arc(s) replacing one or both of the angles 110 and 120. FIG. 5 shows an example of this wherein the saw blade 170 is bent in two arcs 180 and 190 and the cutting portion 210 is only in the area where the saw blade 170 passes through the work surface 200. This allows the positioning portion of the blade comprising the entire blade 170 except the cutting portion 210 to be made robustly eliminating flex in the saw blade 170 and possibly unwanted vibration.

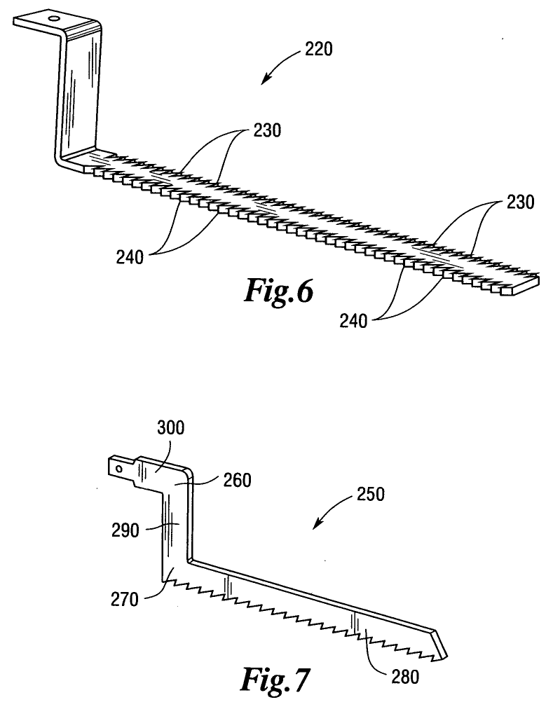

From another aspect FIG. 6 shows the saw blade 100 of FIG. 2A with two cutting edges 230 and 240. This saw blade 220 embodiment allows cutting in both a forward and a rearward direction without the necessity of removing the saw from engagement in a saw kerf or engagement with the work and turning it to cut in an opposite direction. Such blades 220 are desirable especially when a cut is started in other than at one end of the desired cut line and finished by reversing the direction of cut.

FIG. 7 is another embodiment in which the saw blade 250 is made with the first about 90 degree angle 260 and the second about 90 degree angle 270 formed to extend the cutting edge 280 of the saw blade 250 forward from the saw bar for the purpose of moving the cutting edge 280 ahead of any encumbrance from the saw body and allowing the saw to make a flush cut into or toward a surface that protrudes from the work such that it might interfere or limit the ability to cut flush against or to move toward that protruding surface. In this case the offset 290 can be made whatever length is needed to avoid interference from any part of the saw body. In addition the saw blade 250 when formed in this orientation permits less flexing and the thickness of material used to form the attachment portion of the blade 300 and the offset portion 290 can be made of thinner material than in the case of the embodiment shown in FIG. 2A where the offset portion 80 of the blade 100 normally extends the cutting portion 90 of the blade 100 to a position proximate the side of the saw 10 resulting in a flexing of the blade 100 as it reciprocates.

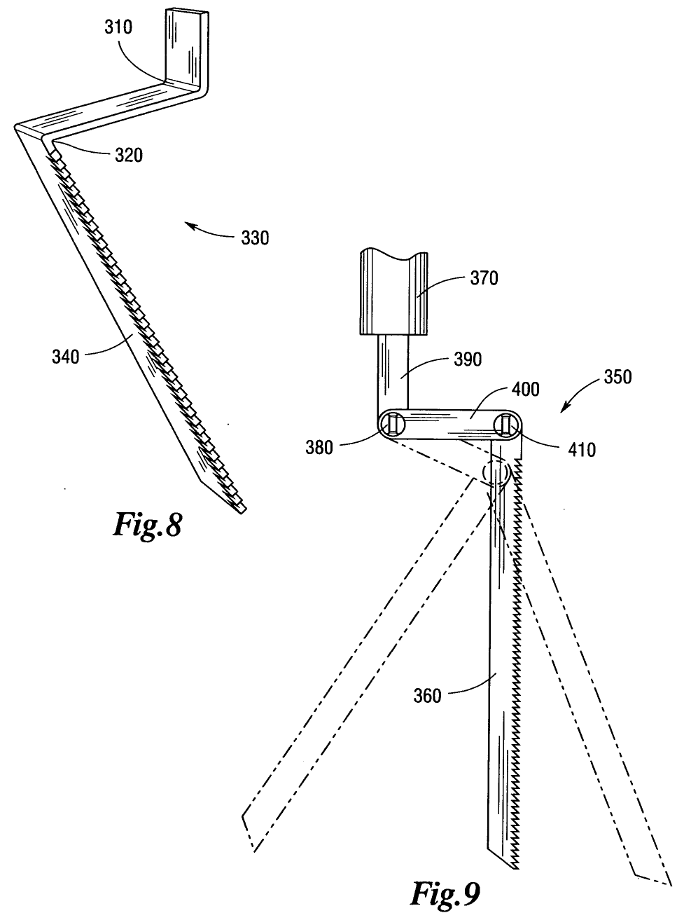

It is desirable to orient the cutting edge of a saw blade at an angle other than strictly parallel to the motion of the saw bar. This is shown in FIG. 8 where the combination of the first angle 310 and the second angle 320 allow the cutting portion 340 of the blade 330 to move in a plane that is parallel to the movement of the saw bar but the cutting portion 340 of the blade 330 is pitched forward allowing the blade 330 to undercut ahead of the point where the blade enters the surface of the work piece. The blade 330 could as easily be pitched backward, away from the point where the blade enters the surface of the work piece permitting material under the surface to be cut behind the point of entry through the surface of the work piece. Accordingly, an angled cut can be made wherein the saw kerf can be angled back away from or, alternatively, cut under a point on the surface of the object or work piece being cut.

In the above situation all parts of the cutting portion of the blade are in a surface that is parallel to the axis of reciprocation. However, it is possible to also form the cutting portion of the blade in a manner wherein the blade departs a surface that is parallel to the axis of reciprocation. Doing so can cause the blade to vibrate severely in use, but the technique can be used to cut shapes in soft materials below the cut line or line of cut and form a void in a material of a shape profiled by the moving profile of the blade as it removes material in its reciprocal motion below the work surface.

In another embodiment FIG. 9 shows how the blade can be made adjustable. FIG. 9 shows an adjustable blade 350, which has been segmented with pivots 380 and 410, mounted in a saw bar 370 of a saw. Although FIG. 9 depicts two pivots, it will be appreciated that any number of pivots can be used within the intended scope of the invention. The advantage of adjustable blades is that the position of the cutting portion of a saw blade can be easily changed depending on what is needed to accomplish the work. As shown in FIG. 9, this arrangement also permits the distance of the offset between the saw bar 370 and the cutting portion of the saw blade 360 to be modified. In this case one or more movable pivots can be used. FIG. 9 presents the case where two pivots 380 and 410 are used to set the angles involved with the offset. These are pivotably connected to the elements of the saw blade assembly 350. FIG. 9 shows the attachment portion of the blade 390 mounted in the saw bar 370. A lockable pivot 380 provides connection to the offset 400 and a second lockable pivot 410 permits further adjustment of the cutting portion 360 of the saw blade assembly 350. The arrangement shown is particularly effective for adjusting the pitch of the cutting portion 360 of the blade 350 as it addresses the work. The multiple pivot arrangement also allows fine adjustment of the depth as well as the angle of the cutting portion 360 of the blade 350 as it addresses the work. The pivots 380, 410 used are lockable, and permit the blade 350 to be used in orientations from the straight orientation of a regular straight solid blade to positioning the cutting portion 360 of the blade ahead of the saw body and its elements, as in FIG. 7, to provide flush cuts with an obstruction protruding from the work surface. Such an obstruction could be a wall arising from a floor as shown in FIG. 1 or it could be some other obstruction encountered when cutting with the blade 350.

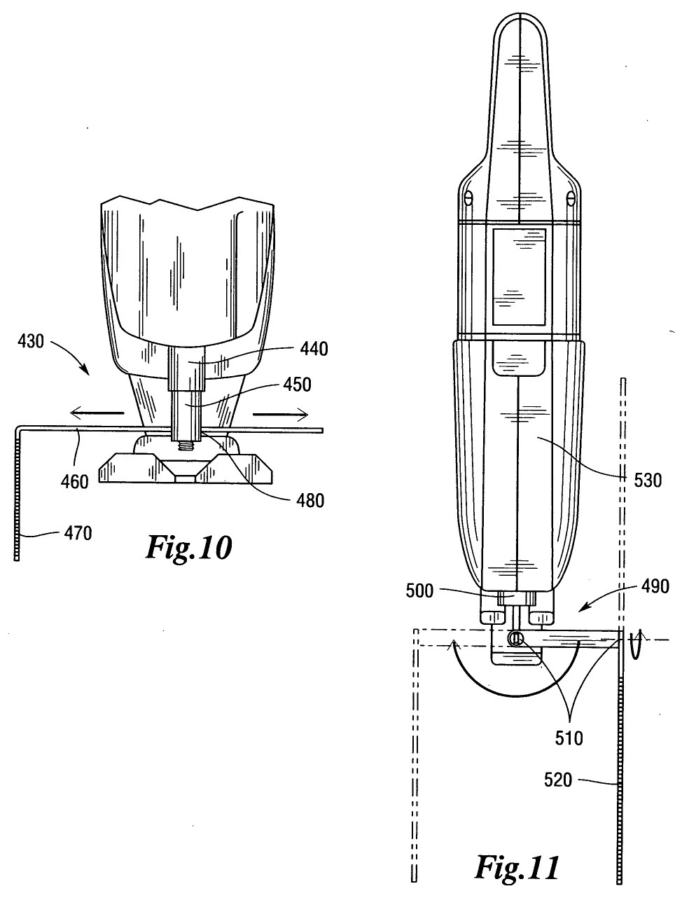

In another embodiment FIG. 10 is a front view of a saw blade 430 mounted in a saw bar 440. In this embodiment the attachment portion 450 of the saw blade 430 is connected at its distal end, the end most distant from the saw bar 440, to an adjustable offset 460 which also comprises the cutting portion 470 of the blade 430. The offset 460 can be moved through the attachment portion 450 pass through 480 and secured in place by various means including but not limited to compression fittings and set screw fittings allowing the cutting portion 470 of the blade 430 to be moved toward or away from the saw body. In the embodiment shown the adjustable offset 460 portion of the saw blade 430 are cylindrical allowing the pitch of the blade, that is its orientation vertical or forward or backward from vertical, and its clearance from the saw body to be adjusted. The adjustable offset 460 can also be made of a non-cylindrically shaped rod having a shape such that the rod can be immobilized in the attachment portion 450 of the saw blade 430 by matching a the shape of the pass through opening 480 in the end of the attachment portion 450 to the shape of the rod material that comprises the adjustable offset 460, though this limits the pitch available to the cutting portion of the blade to pitches that are consistent with varying orientations of the rod as it is fitted through the pass through 480.

From another aspect FIG. 11 is a blade 490 mounted in a saw bar 500 with the saw 530. The blade 490 as shown employs a plurality of pivots 510 which allow the blade 490 to pivot in a plane substantially perpendicular to the direction of cut. This allows the blade 490 to be offset on either side of the saw 530 by adjusting the pivots 510 so that the cutting portion 520 of the blade is positioned offset to the side desired. Using this embodiment flush cuts can be accomplished either to the right or to the left side of the saw permitting improved ease of use and avoidance of obstructions that arise to either side of the saw. FIG. 11 shows the positioning of the cutting portion 520 of the saw blade 490 accomplished by two pivots 510, but more pivots can be installed in the blade 490 to accomplish the desired positioning of the cutting portion 520.

In another embodiment a combination of pivots can be used to allow the blade to pivot in more than one plane. For example, multiple plane pivoting can allow the position of the blade to be changed to control both side-to-side positioning and blade pitch as it approaches the work. FIG. 11 depicts a saw blade 490 in which the cutting portion 520 of the blade 490 can be oriented to the positions depicted with broken lines. In addition to cuts through the work surface, this allows flush cuts against surfaces that protrude above a work surface. The cuts can be perpendicular to the work surface without passing through it.

Those skilled in the art will realize that this invention is capable of embodiments different from those shown and described. It will be appreciated that the detail of the structure of this apparatus and methodology can be changed in various ways without departing from the scope of this invention. Accordingly, the drawings and detailed description of the preferred embodiments are to be regarded as including such equivalents as do not depart from the scope of the invention.

I claim:

1. A saw blade for mounting on a saw bar of a reciprocating saw comprising:
a blade formed of a single piece of material, the blade having a cutting portion;
an offset portion of the blade that offsets the cutting portion of the saw blade from an axis of reciprocation of the saw bar; and
the offset portion offsetting a line of cut of the saw from the axis of reciprocation of the saw bar.

2. The saw blade of claim 1 wherein the saw blade is formed to permit cutting close to an obstructing element of a cutting situation that precludes a saw body passing through the obstructing element.

3. The saw blade of claim 1 wherein the saw blade is formed to provide a cut that is substantially congruent with the intersection of a cutting surface and an obstructing element arising from the cutting surface and is substantially coplanar with the cutting surface.

4. The saw blade of claim 1 wherein the saw blade is formed to provide a cut that is substantially congruent with the intersection of a cutting surface and an obstructing element arising from the cutting surface and is substantially coplanar with the obstructing element.

5. The saw blade of claim 1 wherein offsetting angles formed in the saw blade are strengthened to reduce unwanted movement of the blade.

6. The saw blade of claim 1 wherein the saw blade is strengthened so that the cutting portion of the saw blade cuts the work without flexing the saw blade in a direction perpendicular to the direction of cutting.

7. The saw blade of claim 1 wherein the attachment portion of the blade and the offset portion of the blade are reinforced to prevent unwanted movement of the blade.

8. The saw blade of claim 1 wherein at least one portion of the blade is made of thicker material than the cutting portion of the blade to prevent unwanted movement of the blade.

9. The saw blade of claim 1 wherein the offset portion of the blade allows the cutting portion of the blade to extend beyond the front of the reciprocating saw to provide a cut up to an element in the cutting situation that prevents the saw body from passing through the element.

10. The saw blade of claim 1 wherein the saw blade employs cutting edges on both sides of the cutting portion of the blade for cutting in either of two directions.

11. A saw blade for a reciprocating saw comprising a plurality of parts for causing a cut provided by the saw blade to be offset from the axis of reciprocation of a saw bar, which is part of the reciprocating saw, to which the saw blade is attached, the saw blade further comprising:
an attachment portion of the blade for attaching the blade to the saw bar;
an offset portion of the blade for offsetting the cutting portion of the blade from the axis of reciprocation of the saw bar;
a cutting portion of the blade for supporting a leading edge of the cutting portion of the blade which supports means for cutting; and
means for attaching the parts of the blade together.

12. The saw blade of claim 11 wherein the saw blade is formed to permit cutting close to an obstructing element of a cutting situation that precludes a saw body passing through the obstructing element.

13. The saw blade of claim 11 wherein the saw blade is formed to provide a cut that is substantially congruent with the intersection of a cutting surface element and an obstructing element arising from the cutting surface and is substantially coplanar with one of the elements.

14. The saw blade of claim 11 wherein at least one portion of the blade is made of thicker material than the cutting portion of the blade to prevent unwanted movement of the blade.

15. The saw blade of claim 11 wherein the offset portion of the blade allows the cutting portion of the blade to extend beyond the front of the reciprocating saw to provide a cut up to an element in the cutting situation that prevents the saw body from passing through the element.

16. The saw blade of claim 11 wherein the saw blade employs cutting edges on both the front and back of the cutting portion of the blade for cutting in either of two directions.

17. The saw blade of claim 11 wherein the offset portion of the saw blade is adjustable according to the clearance needs of the cutting situation.

18. The saw blade of claim 11 wherein the saw blade can be offset to either side of a saw to provide flush cutting capability to either side of the saw.

19. A method for making cuts flush to a protruding element from a work surface being cut when using a reciprocating saw comprising:
making a blade for the reciprocating saw of a single piece of material;
forming the blade to include an attachment portion, an offset portion, and a cutting portion;
adjusting the length of the offset portion to allow the blade to reciprocate outside the boundaries of the saw body when attached to the saw;
applying the cutting portion to reciprocate substantially coplanar with the work surface when undercutting the protruding element;
applying the cutting portion to reciprocate substantially perpendicular to the work surface when cutting proximate the protrusion element but not under it; and
passing the saw blade through the material to be cut.

20. The method of claim 19 wherein the offset portion of the saw can be adjusted according to the clearance needs of the cutting situation.
